(19) United States
(12) Patent Application Publication
(10) Pub. No.: US 2025/0067067 A1
(43) Pub. Date: Feb. 27, 2025

(54) PLATFORM ASSEMBLIES FOR MONOPOLE ANTENNAS

(71) Applicant: Outdoor Wireless Networks LLC, Claremont, NC (US)

(72) Inventors: Chao Bu, Suzhou (CN); Bin Ai, Suzhou (CN)

(21) Appl. No.: 18/773,793

(22) Filed: Jul. 16, 2024

(30) Foreign Application Priority Data
Aug. 23, 2023 (CN) 202311065541.8

(51) Int. Cl. E04G 3/24; E04G 5/04; E04G 5/14; H01Q 1/12; H01Q 1/24; H01Q 1/44

(52) U.S. Cl. CPC E04G 3/243; E04G 5/04; E04G 5/14; H01Q 1/1228; H01Q 1/246; H01Q 1/44

(57) ABSTRACT

The present disclosure describes a platform assembly for a monopole. The platform assembly includes a plurality of T-arm assemblies. Each T-arm assembly has a platform frame including a pair of support members, a pair of brace members coupled to and extending between the pair of support members, at least two grating edge members coupled to the support members, and a pair of gratings, each grating coupled to a grating edge member and one of the brace members such that the pair of gratings are separated to define an opening therebetween. Each T-arm assembly further includes an adjustable arm member configured to move relative to the support members and a pair of locking mechanisms, each locking mechanism coupled to a respective support member and configured to secure the adjustable arm member in a desired position in relation to the platform frame. Other platform assemblies and related antenna assemblies are described herein.

### RELATED APPLICATION(S)

The present application claims priority to and benefit of Chinese Patent Application No. 202311065541.8, filed Aug. 23, 2023, the disclosures of which are hereby incorporated herein by references in their entirety.

### FIELD

The present application generally relates to telecommunications equipment, and more particularly, to platform assemblies for monopole antenna structures and related antenna assemblies.

### BACKGROUND

Various types of towers have been constructed for the purpose of supporting one or more antennas, such as those for broadcasting television and radio signals. Some towers are specifically designed for transmitting and receiving cellular telephone signals and other types of radio frequency (RF) signals. As wireless data service demands have grown, a conventional response has been to increase the number and capacity of conventional cellular Base Stations (Macro-Cells). Such Macro-Cells are typically mounted on antenna towers. A conventional antenna tower has three or four legs on which antennas and supporting remote radio units (RRUs) are mounted. However, in some environments structures known as “monopoles” are used as mounting structures. A typical monopole 10 with antennas 20 mounted on mounting frames 30 is shown in FIG. 1. Monopoles are typically employed when fewer antennas/RRUs are to be mounted, and/or when a structure of less height is required.

RF towers (including monopoles) are often designed to allow a person to climb to the top and remain there to install and/or repair RF antennas (e.g., cellular antennas) and other equipment connected to the tower. Platforms 40 are typically mounted near the tops of RF towers (e.g., cellular towers) for supporting workers who may be responsible for installing and/or maintaining RF antennas (e.g., cellular antennas). Such platforms are designed to support the weight of a human and may also be used to support a number of the RF antennas. A monopole platform is a common platform design that can mount multiple different communication devices at the same time. This platform can be fixed on a monopole 10 at different heights. Since monopoles may have different diameters, and the diameter of a monopole may differ at different heights, the ring mount 70 used for securing the platform to the monopole will change with the diameter of the pole and undertake the main load bearing function. There may be a need for alternative monopole platform assemblies that allow for easy fabrication and more efficient installation, while reducing manufacturing costs.

### SUMMARY

A first aspect of the present invention is directed to a platform assembly for a monopole. The platform assembly includes a plurality of T-arm assemblies. Each T-arm assembly has a platform frame including a pair of support members, a pair of brace members coupled to and extending between the pair of support members, at least two grating edge members coupled to the support members, and a pair of gratings, each grating coupled to a grating edge member and one of the brace members such that the pair of gratings are separated to define an opening therebetween. Each T-arm assembly further includes an adjustable arm member configured to move relative to the support members and a pair of locking mechanisms, each locking mechanism coupled to a respective support member and configured to secure the adjustable arm member in a desired position in relation to the platform frame.

A second aspect of the present invention is directed to a platform assembly for a monopole. The platform assembly includes a plurality of T-arm assemblies. Each T-arm assembly has a platform frame including a pair of support members, a pair of brace members coupled to and extending between the pair of support members, at least two grating edge members coupled to the support members, and a pair of gratings, each grating coupled to a grating edge member and one of the brace members such that the pair of gratings are separated to define an opening therebetween. Each T-arm assembly further includes an adjustable arm member configured to move relative to the support members of the platform frame, a pair of locking mechanisms, each locking mechanism coupled to a respective support member and configured to secure the adjustable arm member in a desired position in relation to the platform frame, and at least one reinforcement kit coupled to the adjustable arm of each T-arm assembly.

A third aspect of the present invention is directed to an antenna assembly. The antenna assembly includes a monopole, a ring mount secured to the monopole, and a platform assembly including a plurality of T-arm assemblies. Each T-arm assembly has a platform frame including a pair of support members, a pair of brace members coupled to and extending between the pair of support members, at least two grating edge members coupled to the support members, and a pair of gratings, each grating coupled to a grating edge member and one of the brace members such that the pair of gratings are separated to define an opening therebetween. Each T-arm assembly further includes an adjustable arm member having a mounting plate at one end, the adjustable arm member being configured to move relative to the support members to accommodate for different diameters along the monopole, and a pair of locking mechanisms, each locking mechanism coupled to a respective support member and configured to secure the adjustable arm member in a desired position in relation to the platform frame. Each adjustable arm is secured to the ring mount via the respective mounting plate.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE FIGURES

FIG. 1 is a front perspective view of a conventional monopole with antenna frames and accompanying antennas mounted thereon.

FIG. 2A and FIG. 2B are top views of a monopole platform assembly according to embodiments of the present invention illustrating the adjustability of the assembly to maintain the same profile and same relative position when mounted to different diameter monopoles or different diameters at different heights on a monopole.

FIG. 3 is a top perspective view of a monopole platform assembly according to embodiments of the present invention.

FIG. 4A is a top perspective view of a T-arm assembly according to embodiments of the present invention that may be utilized in the monopole platform assembly of FIG. 3.

FIG. 4B is an enlarged top perspective view of the T-arm assembly of FIG. 4A.

FIG. 4C is a top perspective view of the frame of the T-arm assembly of FIG. 4A according to embodiments of the present invention.

FIG. 4D is a top perspective view of the adjustable arm, support member, and mounting bracket of the T-arm assembly of FIG. 4A.

FIG. 4E is an enlarged perspective view of a connection interface of the adjustable arm and support member of FIG. 4D with a ring mount according to embodiments of the present invention.

FIG. 5A is a perspective view of the adjustable arm and support member of FIG. 4D having an alternative end plate for the connection interface with a ring mount.

FIG. 5B is an enlarged view of the alternative end plate of FIG. 5A.

FIG. 6A is a side view of the T-arm assembly of FIG. 4A for use in “light duty” monopole platform assembly configurations according to embodiments of the present invention.

FIG. 6B is a side view of the T-arm assembly of FIG. 4A for use in “medium duty” monopole platform assembly configurations according to embodiments of the present invention.

FIG. 6C is a side view of the T-arm assembly of FIG. 4A for use in “heavy duty” monopole platform assembly configurations according to embodiments of the present invention.

FIG. 6D is a side view of the T-arm assembly of FIG. 4A for use in “extremely heavy duty” monopole platform assembly configurations according to embodiments of the present invention.

FIGS. 7A-7C illustrates the ability of the monopole platform assembly according to embodiments of the present invention to maintain required spacing between antennas and other telecommunications devices for: (A) four antennas spaced apart on a 13-foot horizontal mounting pipe; (B) four antennas spaced apart on a 15-foot horizontal mounting pipe; and (C) five antennas spaced apart on a 15-foot horizontal mounting pipe.

FIG. 8 is a top view schematic illustrating the spacing obtained for the monopole platform assembly according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention now will be described more fully hereinafter with reference to the accompanying drawings, in which illustrative embodiments of the invention are shown. Like numbers refer to like elements throughout and different embodiments of like elements can be designated using a different number of superscript indicator apostrophes (e.g., 10′, 10″, 10′″).

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

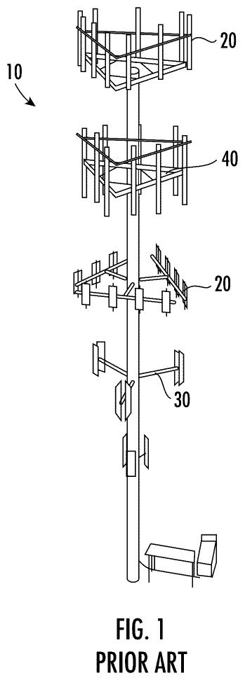

Pursuant to embodiments of the present invention, platform assemblies for a monopole are provided. The platform assemblies of the present invention include a T-arm assembly that can allow the platform assembly to keep the same profile and same relative position anywhere on the monopole (i.e., the outer profile of the platform assembly remains the same at different diameters). This also allows for different antenna configurations on the platform assembly with reduced passive intermodulation (PIM) interference. The platform assemblies of the present invention include a split deck (platform) configuration which can allow an RRU or other telecommunications device mount kit to be secured to an adjustable arm member of the T-arm assembly, thereby allowing one or more RRUs or other telecommunications devices to be mounted internally from the antennas mounted on the vertical antenna pipes of the platform assembly. The platform assemblies of the present invention may further include a built-in “kicker” reinforcement kit which can enhance the load capacity of the platform assembly. The platform assemblies of the present invention have a high adaptability for different load configurations (e.g., light, medium, heavy, and extremely heavy), thereby allowing flexibility while also controlling costs. Embodiments of the present invention will now be discussed in greater detail with reference to FIGS. 1A-8.

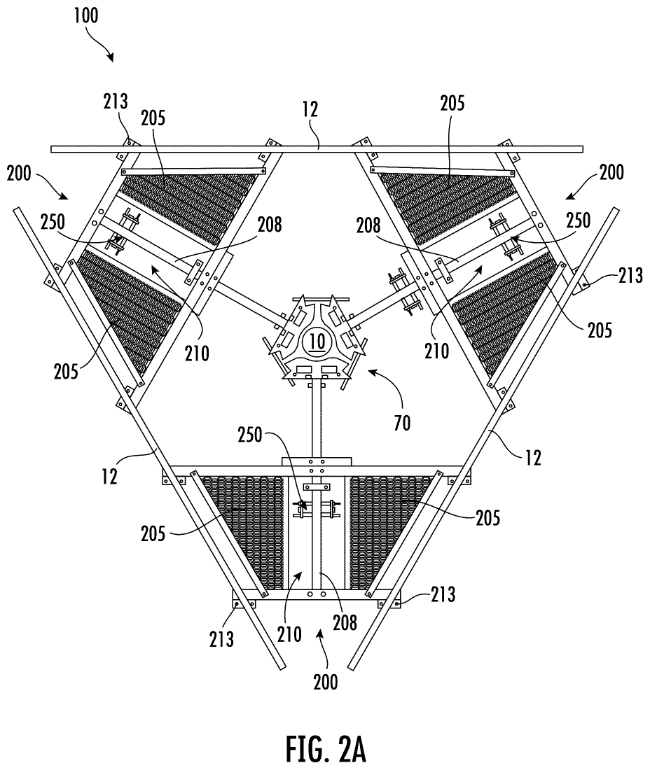

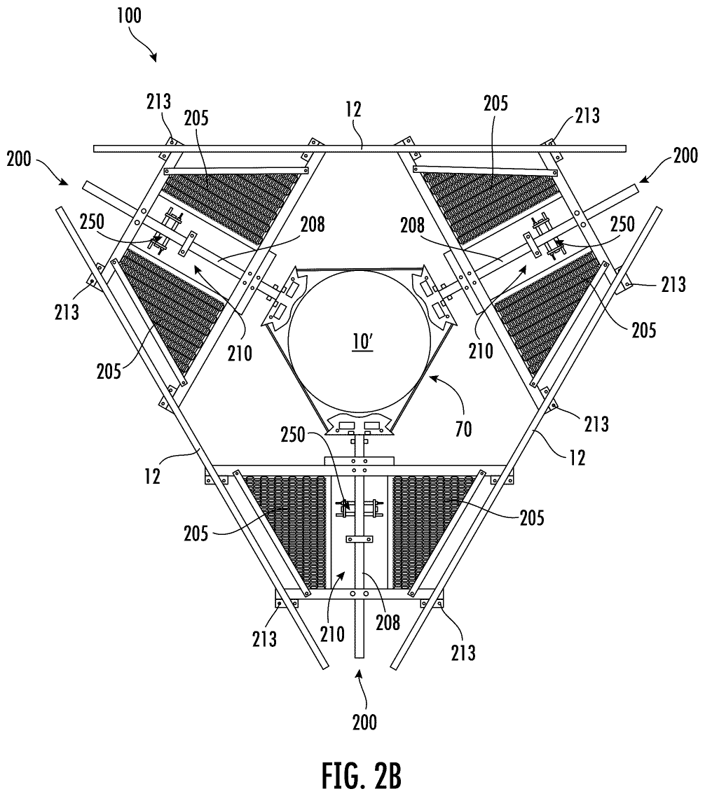

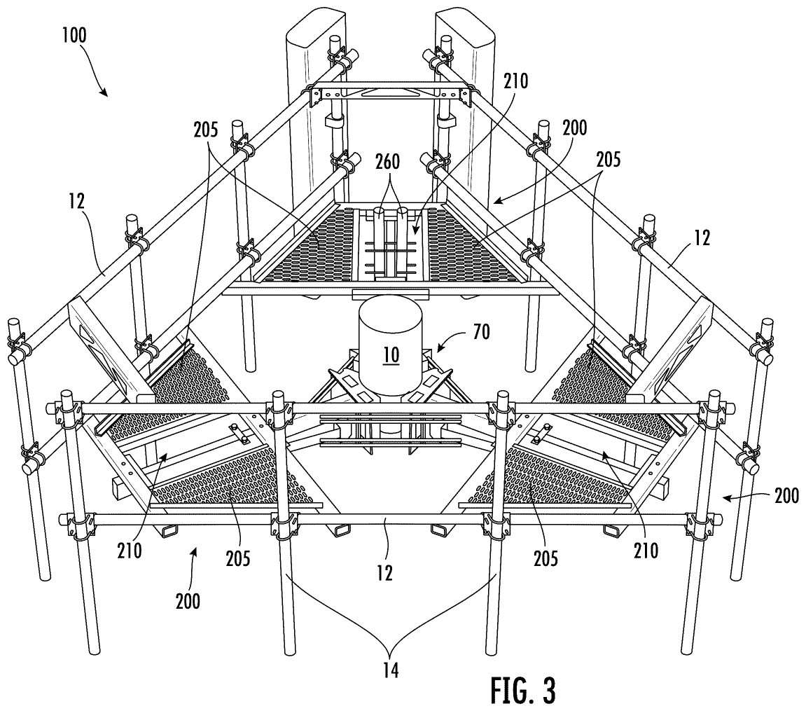

Referring to FIGS. 2A-2B and FIG. 3, a platform assembly 100 according to embodiments of the present invention is illustrated. The platform assembly 100 is configured to be secured to a monopole 10, 10′ via an existing mount (e.g., ring mount 70). The platform assembly 100 includes a plurality of T-arm assemblies 200 which provide the platform assembly 100 with the flexibility to be secured to different diameter monopoles 10, 10′ (or diameters at different heights of a respective monopole 10, 10′). For example, in some embodiments, the platform assembly 100 includes three T-arm assemblies 200. As shown in FIGS. 2A-2B, according to embodiments of the present invention, the platform assembly 100 is configured to maintain the same profile and same relative position (e.g., the position of the T-arm assemblies 200 in relation to the horizontal mounting pipe 12) irrespective of the diameter of the monopoles 10, 10′. This allows the platform assembly 100 to be used to fit different antenna configurations while maintaining the ability to guard against passive intermodulation (PIM).

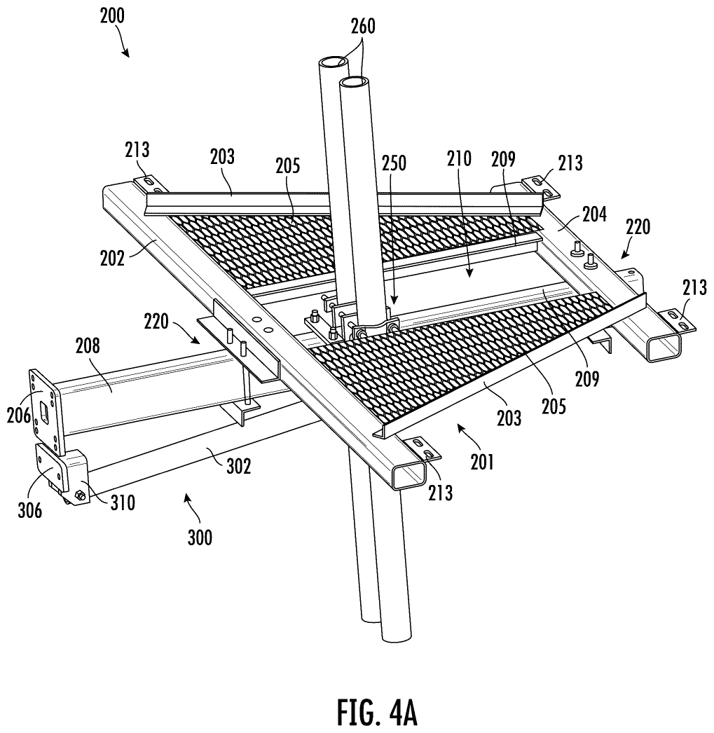

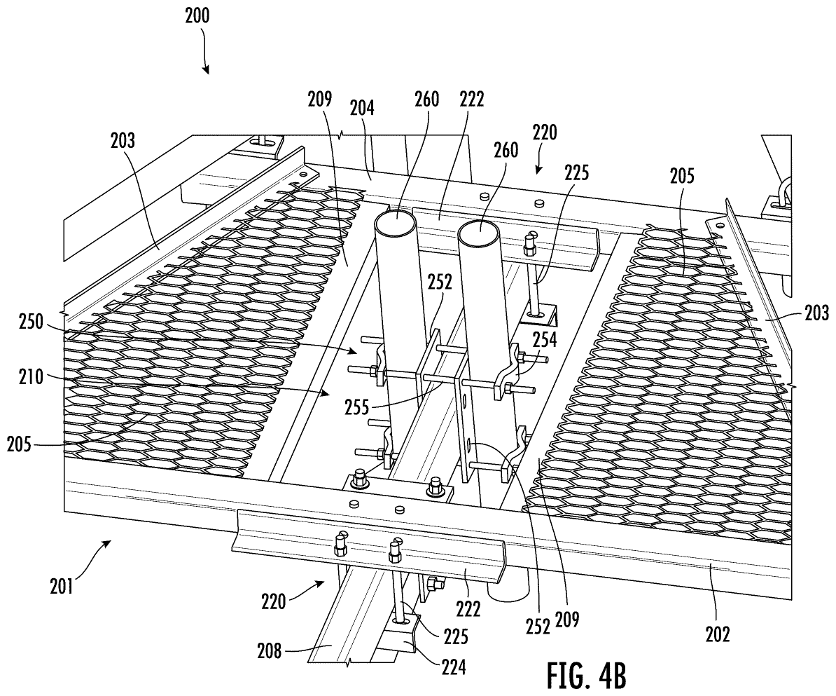

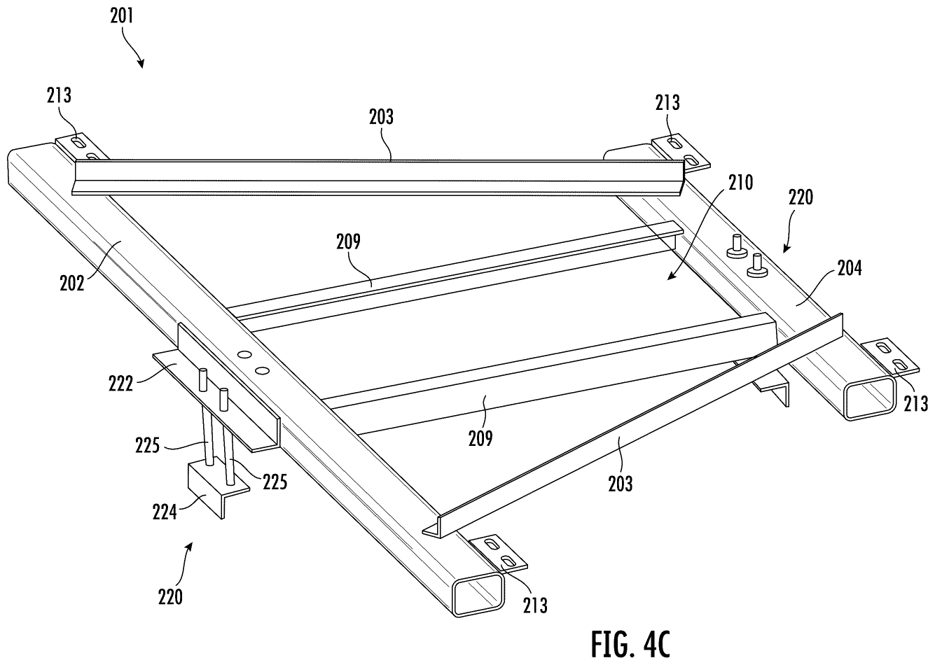

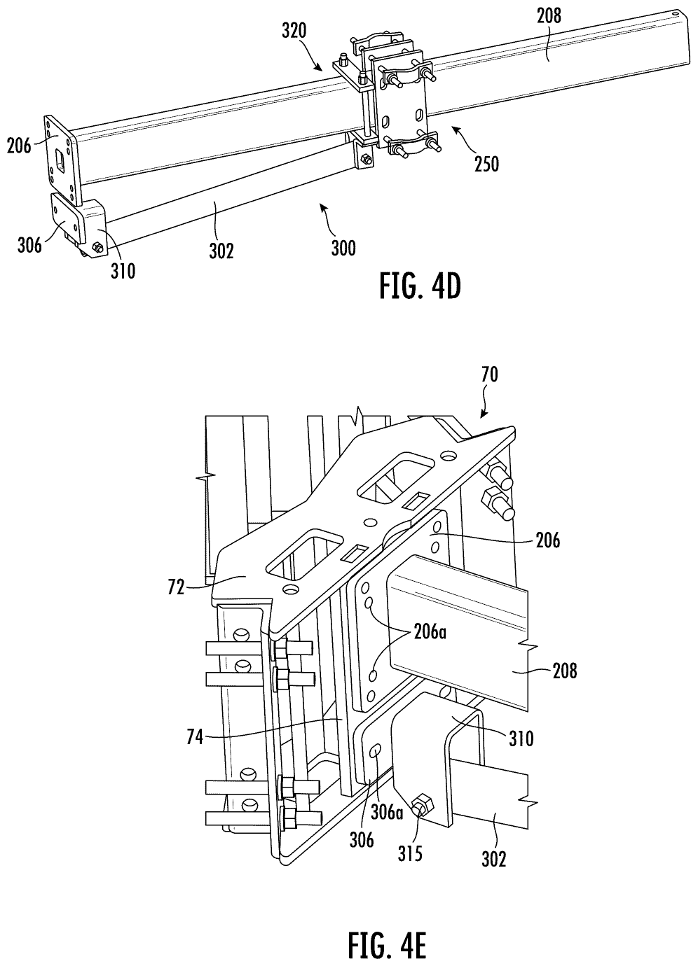

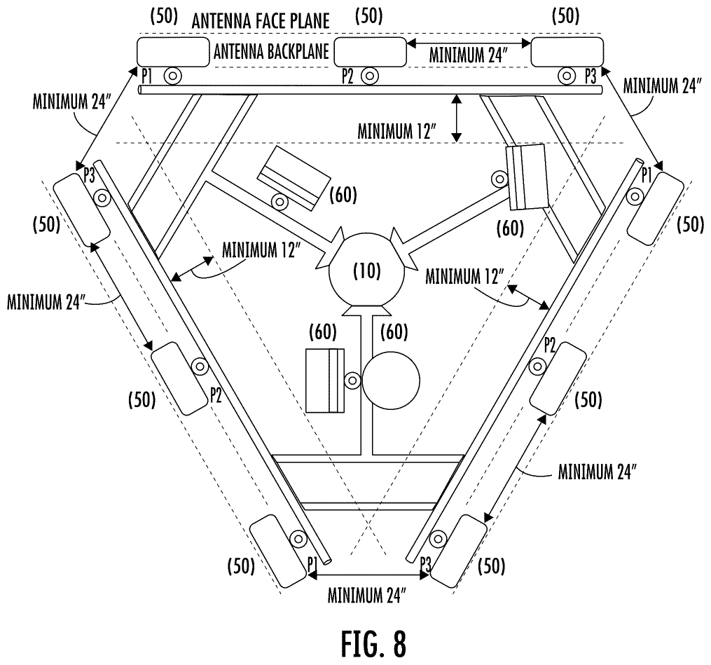

In addition, according to embodiments of the present invention, as shown in FIGS. 2A-2B and FIG. 3, each of the T-arm assemblies 200 include a “split-deck” configuration in which the gratings (platforms) 205 of each T-arm assembly 200 are separated by an opening or gap 210 (see also, e.g., FIGS. 4A-4B). As discussed in further detail below, the opening 210 between the gratings 205 allow for one or more mounting pipes 260 to be mounted to an adjustable arm member 208 of the respective T-arm assembly 200 (see also, e.g., FIG. 3 and FIGS. 4A-4B). This allows RRUs or other telecommunications devices 60 secured to the mounting pipes 260 to be positioned a minimum required distance (e.g., 12 inches) from the horizontal mounting pipe 12 (and antennas 50) as required by telecommunications carrier standard specifications (see, e.g., FIG. 8).

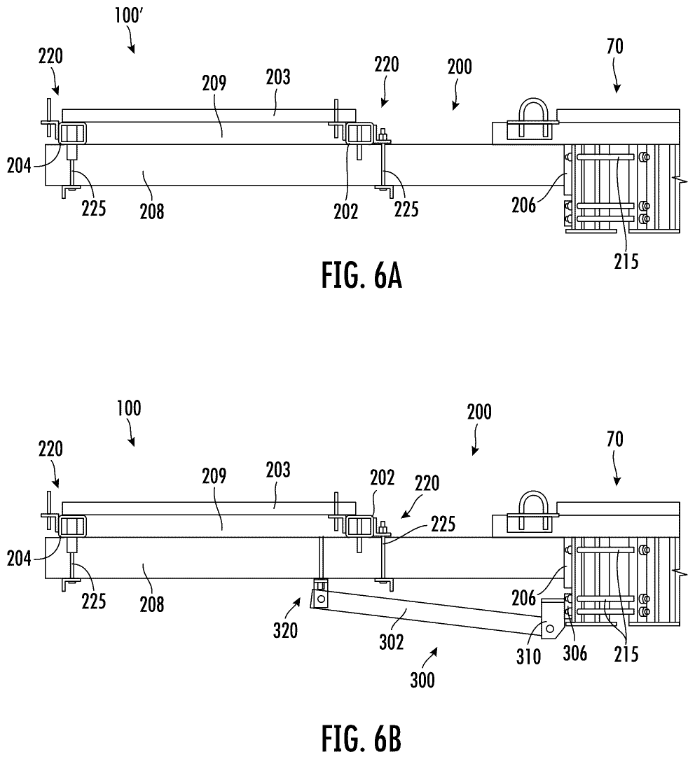

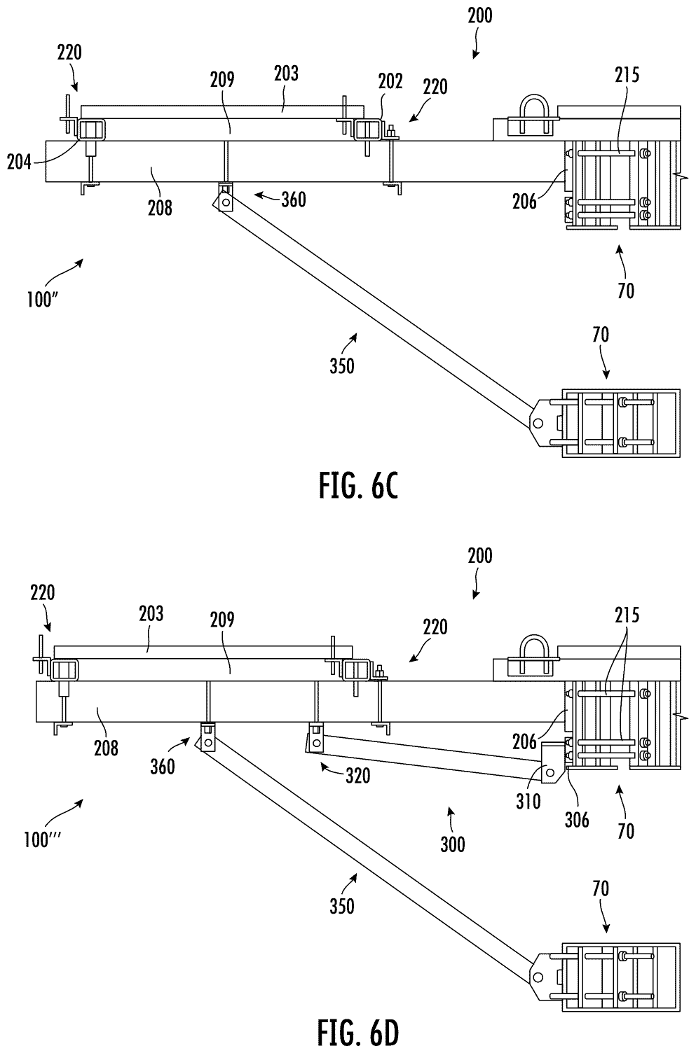

The platform assembly 100 may include one or more reinforcement kits 300, 350 coupled to each T-arm assembly 200. The one or more reinforcement kits 300, 350 are configured to help support the T-arm assemblies 200 and allows the platform assembly 100 the adaptability to accommodate different load capacities (i.e., light duty, medium duty, heavy duty, and extremely heavy duty) (see, e.g., FIGS. 6A-6D).

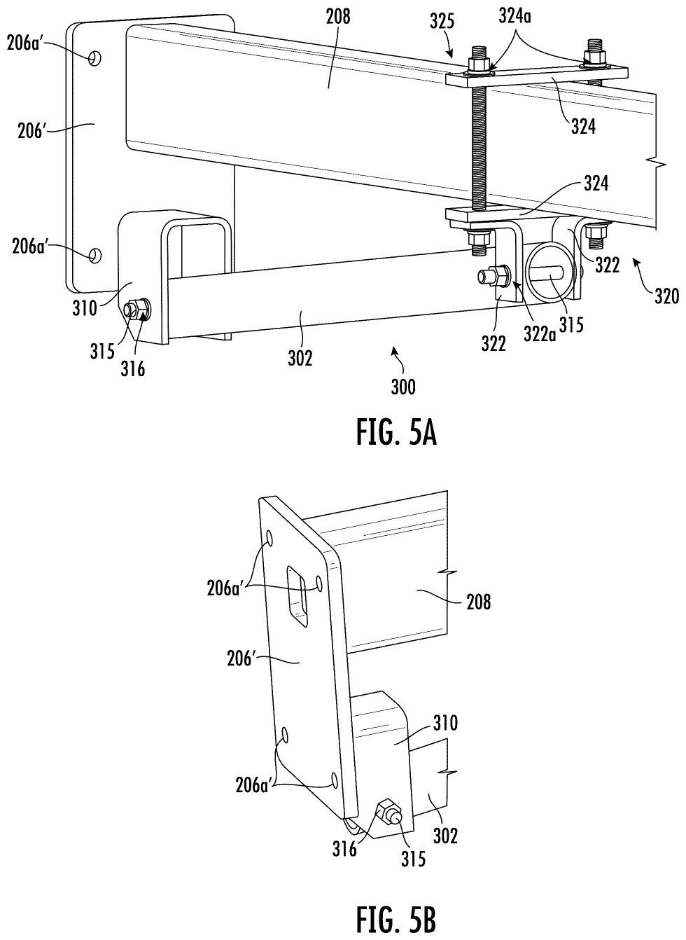

Referring now to FIGS. 4A-4E and FIGS. 5A-5B, a T-arm assembly 200 and reinforcement kit 300 according to embodiments of the present invention are illustrated. As shown in FIG. 4A-4C, each T-arm assembly 200 may include a platform frame 201 and an adjustable arm member (or spindle) 208. In some embodiments, the adjustable arm member 208 is tubular with a rectangular cross-section; in some instances, a rectangular arm member having an aspect ratio of height: width of greater than 1 (i.e., the adjustable arm member 208 is taller than it is wide). A mounting plate 206 may be coupled to one end of the adjustable arm member 208. In some embodiments, the mounting plate 206 is configured to secure the adjustable arm member 208 to a ring mount 70. As discussed in further detail below, in some embodiments, the adjustable arm member 208 is configured to move (e.g., slide) relative to the platform frame 201, thereby allowing the T-arm assembly 200 to be adjustable, for example, to accommodate the different diameters along the monopole 10, 10′ that may be encountered by the T-arm assembly 200 (see, e.g., FIGS. 2A-2B).

As shown in FIGS. 4A-4C, the platform frame 201 may include a pair of support members 202, 204 and a pair of brace members 209. The brace members 209 are coupled to the support members 202, 204 and extend parallel to each other and between the support members 202, 204. The pair of the brace members 209 are spaced apart to help define the opening or gap 210 between the gratings 205. The brace members 209 also provide additional structural support to strengthen the platform frame 201.

In some embodiments, one or more mounting pipes 260 are mounted on the adjustable arm member 208 via a mounting bracket 250. The one or more mounting pipes 260 extend through the opening 210 between the brace members 209 and grating 205. As shown in FIG. 4B, in some embodiments, the mounting bracket 250 for the mounting pipes 260 may include a pair of plate members 252, a plurality of clamping members 254, and a plurality of fasteners 255 (e.g., threaded rods or bolts and nuts). In some embodiments, the adjustable arm member 208 is sandwiched between the pair of plate members 252. A respective mounting pipe 260 may be placed between one or more of the clamping members 254 and one of the plate members 252. The plurality of fasteners 255 are inserted through aligned apertures in both plate members 252 and corresponding clamping members 254 and tightened to secure the mounting bracket 250 (and mounting pipes 260) to the adjustable arm member 208.

The mounting pipes 260 are configured such that one or more RRUs (or other telecommunications devices) 60 can be mounted thereon. The mounting pipes 260 help position the one or more RRUs (or other devices) 60 internally (i.e., closer to the monopole 10, 10′) from the one or more antennas 50 that are mounted on the vertical antenna pipes 14 of the platform assembly 100. For example, in some embodiments, the mounting pipes 260 are positioned internally on the platform assembly 100 with respect to the horizontal mounting pipe 12 such that the one or more antennas 50 and other telecommunications devices 60 are spaced apart a minimum required distance (e.g., 12 inches) from each other (see, e.g., FIG. 8). The platform assembly 100 provides the ability to mount antennas 50 to the vertical antenna pipes 14 and mount the RRUs or other devices 60 to the mounting pipes 260 extending through the opening 210 in the T-arm assembly 200 (i.e., the internal mounting ability) without interfering with each other, which helps protect against PIM for all mounting locations on the platform assembly 100.

Referring to FIG. 4C, in some embodiments, mounting brackets 213 are coupled to opposing ends of each support member 202, 204. In some embodiments, the mounting brackets 213 are configured to secure the platform frame 201 to horizontal mounting pipes 12 of the platform assembly 100 (see, e.g., FIGS. 2A-2B). For example, in some embodiments, the horizontal mounting pipes 12 may be supported by and/or engage with the support members 202, 204 and mounting brackets 213 such that the horizontal mounting pipes 12 sit on top of and are secured to the top surfaces of the support members 202, 204 and mounting brackets 213. See also, e.g., U.S. Patent Application Publication No. 2023/0024333 to Ojha et al., the disclosure of which is hereby incorporated by reference in its entirety.

As shown in FIGS. 4A-4C, in some embodiments, the platform frame 201 of the T-arm assembly 200 further comprises at least two grating edge members 203. The grating edge members 203 are coupled to the support members 202, 204. In addition, each platform frame 201 includes a pair of gratings (or platforms) 205 coupled to the grating edge members 203 and brace members 209 (see, e.g., FIGS. 4A-4B). As shown in FIGS. 4A-4B, the opening 210 defined by the brace members 209 resides between the pair of gratings 205 such that the one or more mounting pipes 260 are able to extend through the opening 210 and between the gratings 205. The gratings 205 may be supported by the grating edge members 203, the support members 202, 204, the brace members 209, thereby providing a work platform on which a technician can stand. In some embodiments, the components of the T-arm assembly 200 that define the platform frame 201 are formed of a weldment, except for the adjustable arm member 208 which is allowed to move relative to the platform frame 201. In some embodiments, the T-arm assembly 200 may comprise galvanized steel.

Still referring to FIGS. 4A-4C, the T-arm assembly 200 further includes a pair of locking mechanisms 220. In some embodiments, each locking mechanism 220 is coupled to a respective support member 202, 204. In some embodiments, tach locking mechanism 220 may comprise an upper bracket member 222 and a lower bracket member 224. Each upper bracket member 222 may be secured to the respective support member 202, 204. In some embodiments, the upper bracket members 222 of the locking mechanisms 220 may have an L-shaped profile which helps to provide further structural support to the T-arm assembly 200. Each upper bracket member 222 is coupled to a corresponding lower bracket member 224 via a pair of securing features 225 (e.g., bolts, threaded rods or the like). The pairs of securing features 225 are spaced apart such that the adjustable arm member 208 may be inserted (and slid) therebetween (see, e.g., FIGS. 4A-4B). In some embodiments, the upper and lower bracket members 222, 224 of the locking mechanisms 220 are configured such that adjustable arm members 208 having different heights may be clamped therebetween.

As shown in FIGS. 4A-4B, the adjustable arm member 208 is positioned to extend between the upper and lower bracket members 222, 224 of the respective locking mechanisms 220, and is slidable (i.e., adjustable) therebetween to accommodate different diameters along the height of the monopole 10, 10′ (see, e.g., FIGS. 2A-2B). Once the adjustable arm member 208 is moved (e.g., slid) to a desired position (i.e., the adjustable arm member 208 and mounting plate 206 are positioned against the ring mount 70 secured to the monopole 10, 10′, the securing features 225 of the locking mechanisms 220 are tightened to clamp the adjustable arm member 208 between corresponding upper and lower bracket members 222, 224 of the respective locking mechanisms 220, thereby securing the adjustable arm member 208 in the desired position relative to the platform frame 201 and against the monopole 10, 10′. Alternative locking mechanism and/or brackets that may be utilized with the T-arm assembly 200 and platform assembly 100 of the present invention are described in co-owned U.S. Patent Application Publication No. 2023/0399859 to Ai et al., the disclosure of which is hereby incorporated by reference in its entirety.

Referring to FIG. 4A, FIGS. 4C-4D, and FIGS. 5A-5B, in some embodiments, the T-arm assembly 200 further includes one or more reinforcement kits 300, 350 (see also, e.g., FIGS. 6A-6D). The reinforcement kit 300 shown in FIG. 4A, FIG. 4C, and FIG. 5A is configured to be secured to the adjustable arm member 208 to provide additional structural support to the T-arm assembly 200 (e.g., for enhanced load capacity of the platform assembly 100). In some embodiments, the reinforcement kit 300 is also configured to be secured to the same ring mount 70 as the T-arm assembly 200 (i.e., the adjustable arm member 208). The reinforcement kit 300 of the present invention is different than a traditional reinforcement kit 350 which requires a second ring mount 70 to secure the reinforcement kit 350 to the monopole 10, 10′ (see, e.g., FIG. 6D). The “built-in” reinforcement kit 300 of the present invention allows the platform assembly 100 the ability to handle heavier load capacities without having to use thick or high-grade materials, thereby making the platform assembly 100 of the present invention lighter than a traditional “heavy duty” platform assembly. However, as discussed further below, in some embodiments of the present invention, a traditional reinforcement kit 350 may still be used with the T-arm assembly 200 (see, e.g., FIGS. 6C-6D).

As shown in FIG. 4C and FIG. 5A, in some embodiments, the reinforcement kit 300 includes a main support member 302 (e.g., a pipe), a mounting bracket 310 and a locking mechanism 320. In some embodiments, the main support member 302 may be pivotably coupled to the mounting bracket 310 and/or the locking mechanism 320. As shown in FIG. 4D and FIG. 5A, the mounting bracket 310 of the reinforcement kit 300 is configured to receive an end of the main support member 302 which is secured to the mounting bracket 310 via a fastener 315 (e.g., bolt and nut). The locking mechanism 320 of the reinforcement kit 300 is secured to the opposing end of the main support member 302 and is configured to engage the adjustable arm member 208 in a similar manner as the locking mechanisms 220 of the T-arm assembly 200 described herein. For example, as shown in FIG. 5A, in some embodiments, the locking mechanism 320 of the reinforcement kit 300 includes a pair of clamping brackets 324 which are coupled together via a pair of securing features 325 (e.g., threaded bolts and nuts or the like). The securing features 325 extend through aligned apertures 324a in the clamping brackets 324. In some embodiments, a pair of main support brackets 322 are coupled to one of the clamping brackets 324 (i.e., the lower clamping bracket) of the locking mechanism 320. For example, in some embodiments, the securing features 325 further extend through aligned apertures 322a in the main support brackets 322 and the (lower) clamping bracket 324 to secure the brackets 322, 324 together. The main support brackets 322 are spaced apart from each other and positioned such that an end of main support member 302 may be secured therebetween via a fastener 315 (e.g., bolt and nut).

Once the locking mechanism 320 of the reinforcement kit 300 is positioned at a desired location along the adjustable arm member 208 (i.e., the adjustable arm member 208 resides between the clamping brackets 324), the securing features 325 are tightened to clamp the adjustable arm member 208 between the clamping brackets 324 of the locking mechanism 320, thereby securing the reinforcement kit 300 at the desired position along the adjustable arm member 208.

In some embodiments, the mounting bracket 310 of the reinforcement kit 300 is coupled to a mounting plate 306, 206′ which is configured to be secured to the ring mount 70. As shown in FIG. 4A, FIG. 4C, and FIG. 4D, in some embodiments, the mounting plate 306 may be a separate plate from the mounting plate 206 coupled to an end of the adjustable arm member 208. As shown in FIG. 4D, the separate mounting plates 206, 306 are configured to be secured to a mounting plate 74 of the ring mount 70 (e.g., via fasteners 215 received through aligned apertures 206a, 306a in the mounting plates 206, 306, respectively, and the mounting plate 74 of the ring mount 70) (see also, e.g., FIGS. 6A-6D). In other embodiments, for example, as shown in FIGS. 5A-5B, the mounting plates 206, 306 may be replaced with a single mounting plate 206′ on which both the adjustable arm member 208 and the mounting bracket 310 of the reinforcement kit 300 are secured (e.g., via welding). The single mounting plate 206′ may be secured to the mounting plate 74 of the ring mount 70 in a similar manner (i.e., via fasteners 215 received through aligned apertures 206a′ in the mounting plate 206′ and the mounting plate 74 of the ring mount 70) to secure the T-arm assembly 200 and the reinforcement kit 300 to the ring mount 70.

Referring now to FIGS. 6A-6D, different platform configurations, i.e., combinations of the T-arm assembly 200 and reinforcement kit(s) 300, 350, according to embodiments of the present invention are illustrated. The different platform configurations may be implemented on a monopole 10, 10′ based on the load capacity required for the respective platform assembly 100, 100′, 100″, 100′″.

The platform assembly 100′ illustrated in FIG. 6A shows the T-arm assembly 200 without a reinforcement kit 300, 350. The configuration of the platform assembly 100′ shown in FIG. 6A may be used for a “light duty” load capacity, as understood in the field. The platform assembly 100 illustrated in FIG. 6B shows the T-arm assembly 200 with the reinforcement kit 300 as described herein. The configuration of the platform assembly 100 shown in FIG. 6B may be used for a “medium duty” load capacity, as understood in the field. The platform assembly 100″ illustrated in FIG. 6C shows the T-arm assembly 200 with a traditional reinforcement kit 350. As noted above, and shown in FIG. 6C, the reinforcement kit 350 requires an additional ring mount 70 that is secured to the monopole 10, 10′. The configuration of the platform assembly 100″ shown in FIG. 6C may be used for a “heavy duty” load capacity, as understood in the field. The platform assembly 100′″ illustrated in FIG. 6D shows the T-arm assembly 200 with two reinforcement kits 300, 350. The configuration of the platform assembly 100′″ shown in FIG. 6D may be used for an “extremely heavy duty” load capacity, as understood in the field. As shown above, the platform assemblies 100, 100′, 100″, 100′″ of the present invention provide high adaptability for different load configurations making the platform design of the present invention more modular and flexible while also helping to better control costs.

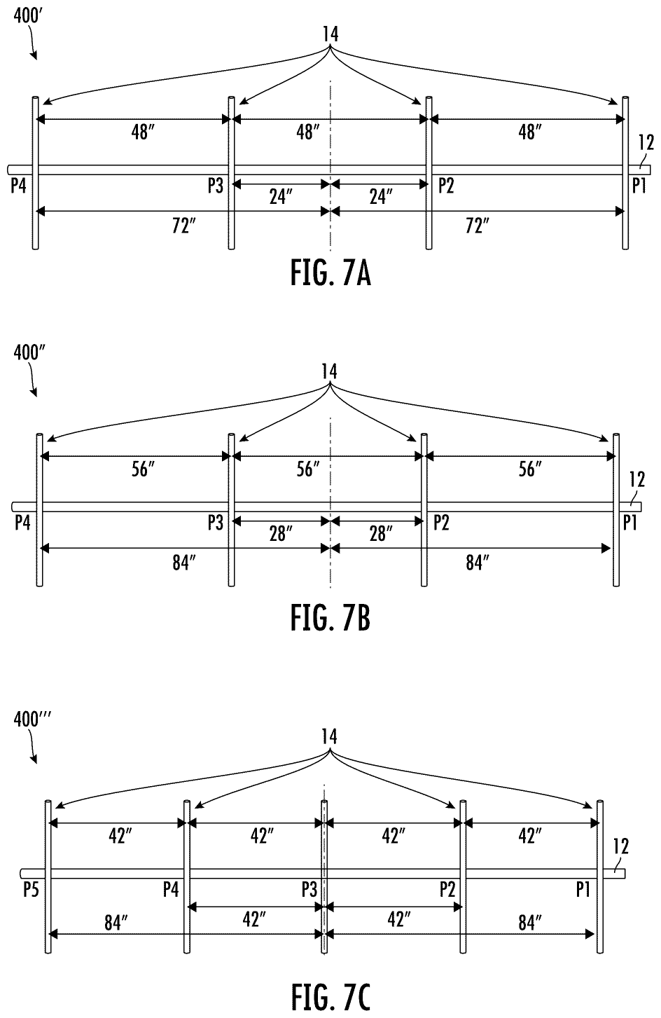

FIGS. 7A-7C and FIG. 8 illustrate how the platform assemblies 100, 100′, 100″, 100′″ of the present invention are configured to maintain certain distances between antennas 50 and other devices 60 mounted to the assembly (which may be required by telecommunications carrier standards) within the limited space available while also being able to avoid PIM and structural issues as much as possible. FIGS. 7A-7C show how antennas 50 (i.e., antenna mounting pipes 14) may be spaced apart with respect to: four antennas 50 on a 13-foot horizontal mounting pipe (FIG. 7A); four antennas 50 on a 15-foot horizontal mounting pipe (FIG. 7B); and five antennas 50 on a 15-foot horizontal mounting pipe (FIG. 7C).

FIG. 8 illustrates exemplary standard specifications that were taken into consideration in the design of the platform assemblies 100, 100′, 100″, 100″ of the present invention. For example, the platform assemblies 100, 100′, 100″, 100′″ of the present invention allow for the antennas 50 to be spaced a minimum of 24 inches from each other along the horizontal mounting pipe 12 and at the ends of the adjacent horizontal mounting pipe 12. The platform assemblies 100, 100′, 100″, 100′″ further allow for the RRUs (or other devices) 60 mounted internally from the horizontal mounting pipe 12 to be spaced a minimum of 12 inches from the horizontal mounting pipe 12. In addition, the platform assemblies 100, 100′, 100″, 100′″ avoid impact of structural supports with the placement of vertical antenna pipes 14 in standardized positions along the horizontal mounting pipe 12.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed is:

1. A platform assembly for a monopole, the platform assembly comprising a plurality of T-arm assemblies, each T-arm assembly comprising:
a platform frame, the platform frame comprising:
a pair of support members;
a pair of brace members coupled to and extending between the pair of support members;
at least two grating edge members coupled to the support members; and
a pair of gratings, each grating coupled to a grating edge member and one of the brace members, wherein the pair of gratings are separated to define an opening therebetween;
an adjustable arm member configured to move relative to the support members; and
a pair of locking mechanisms, each locking mechanism coupled to a respective support member and configured to secure the adjustable arm member in a desired position in relation to the platform frame.

2. The platform assembly according to claim 1, further comprising one or more mounting pipes secured to the adjustable arm member via a mounting bracket, the one or more mounting pipes extending through the opening between the pair of gratings, and configured to have one or more remote radio units or other telecommunications devices mounted thereon.

3. The platform assembly according to claim 1, further comprising one or more reinforcement kits coupled to each T-arm assembly.

4. The platform assembly according to claim 1, wherein the adjustable arm member is tubular with a rectangular cross-section.

5. The platform assembly according to claim 1, further comprising a mounting plate coupled to one end of the adjustable arm member, the mounting plate configured to secure the adjustable arm member to a ring mount secured on the monopole.

6. The platform assembly according to claim 1, further comprising a plurality of horizontal mounting members, and wherein the platform frame further comprises mounting brackets coupled to opposing ends of each support member, the mounting brackets configured to secure the platform frame to the horizontal mounting members of the platform assembly.

7. The platform assembly according to claim 1, wherein each locking mechanism comprises an upper bracket member and a lower bracket member, the upper bracket member secured to the respective support member and coupled to the corresponding lower bracket member via a pair of securing features, the pair of securing features being spaced apart such that the adjustable arm member may be inserted therebetween.

8. The platform assembly according to claim 3, wherein the reinforcement kit includes a main support member, the main support member being coupled to a mounting bracket and a locking mechanism at opposing ends, the locking mechanism configured to engage the adjustable arm member.

9. The platform assembly according to claim 8, wherein the locking mechanism of the reinforcement kit includes a pair of clamping brackets coupled together via a pair of securing features, and a pair of main support brackets coupled to one of the clamping brackets, the main support brackets being spaced apart from each other and positioned such that the main support member is secured therebetween.

10. A platform assembly for a monopole, the platform assembly comprising a plurality of T-arm assemblies, each T-arm assembly comprising:
a platform frame, the platform frame comprising:
a pair of support members;
a pair of brace members coupled to and extending between the pair of support members;
at least two grating edge members coupled to the support members; and
a pair of gratings, each grating coupled to a grating edge member and one of the brace members, wherein the pair of gratings are separated to define an opening therebetween;
an adjustable arm member configured to move relative to the support members;
a pair of locking mechanisms, each locking mechanism coupled to a respective support member and configured to secure the adjustable arm member in a desired position in relation to the platform frame; and
at least one reinforcement kit coupled to the adjustable arm of each T-arm assembly.

11. The platform assembly according to claim 10, further comprising a mounting plate coupled to one end of the adjustable arm member, the mounting plate configured to secure the adjustable arm member to a ring mount secured on the monopole.

12. The platform assembly according to claim 10, wherein each locking mechanism comprises an upper bracket member and a lower bracket member, the upper bracket member secured to the respective support member and coupled to the corresponding lower bracket member via a pair of securing features, the pair of securing features being spaced apart such that the adjustable arm member may be inserted therebetween.

13. The platform assembly according to claim 10, wherein the reinforcement kit includes a main support member, the main support member being coupled to a mounting bracket and a locking mechanism at opposing ends, the locking mechanism configured to engage the adjustable arm member.

14. The platform assembly according to claim 10, further comprising one or more mounting pipes secured to the adjustable arm member via a mounting bracket, the one or more mounting pipes extending through the opening between the pair of gratings.

15. A platform assembly for a monopole, the platform assembly comprising a plurality of T-arm assemblies, each T-arm assembly comprising:
a platform frame, the platform frame comprising:
a pair of support members;
a pair of brace members coupled to and extending between the pair of support members;
at least two grating edge members coupled to the support members; and
a pair of gratings, each grating coupled to a grating edge member and one of the brace members, wherein the pair of gratings are separated to define an opening therebetween; and
an arm member coupled to the pair of support members, the arm member configured to secure the platform frame to a monopole.

16. The platform assembly according to claim 15, further comprising one or more mounting pipes secured to the arm member via a mounting bracket, the one or more mounting pipes extending through the opening between the pair of gratings, and configured to have one or more remote radio units or other telecommunications devices mounted thereon.

17. The platform assembly according to claim 15, further comprising one or more reinforcement kits coupled to each T-arm assembly.

18. The platform assembly according to claim 15, wherein the arm member is tubular with a rectangular cross-section.

19. The platform assembly according to claim 15, further comprising a mounting plate coupled to one end of the arm member, the mounting plate configured to secure the arm member to a ring mount secured on the monopole.

20. The platform assembly according to claim 15, wherein the arm member is configured to move relative to the support members such that the platform assembly can be adjusted to accommodate different diameter monopoles.
